(19) United States
(12) Patent Application Publication
(10) Pub. No.: US 2017/0205042 A1
(43) Pub. Date: Jul. 20, 2017

(54) LIGHTING ASSEMBLY WITH ELONGATED LIGHTGUIDE

(71) Applicant: 3M INNOVATIVE PROPERTIES COMPANY, St. Paul, MN (US)

(72) Inventor: Jun-Hyeoung Kim, Gyunggi-do (KR)

(21) Appl. No.: 15/324,348

(22) PCT Filed: Jul. 23, 2015
(86) PCT No.: PCT/US2015/041772

§ 371 Date: Jan. 6, 2017

Related U.S. Application Data
(60) Provisional application No. 62/029,738, filed on Jul. 28, 2014.

(51) Int. Cl. F21S 8/10; B60Q 1/26; B60Q 1/00; B60Q 1/30

(52) U.S. Cl. CPC F21S 48/2231; F21S 48/2218; F21S 48/234; F21S 48/2281; B60Q 1/30; B60Q 1/2696; B60Q 1/0011

(57) ABSTRACT

The present disclosure provides a lighting system having elongated lightguides disposed in elongated optical cavities that exhibit a uniform surface emission, a vehicle light assembly using the lighting system, and automotive exterior lamps incorporating the vehicle light assemblies. In one particular embodiment, the lighting system includes an elongated lightguide disposed in a reflective elongated optical cavity. The reflective elongated optical cavity can include a diffuse output surface, and the lighting system can have one or more LEDs positioned to inject light into the elongated lightguide.

### BACKGROUND

Surface lighting is the new trend for automotive exterior lamps. Many lamp makers and automotive Original Equipment Manufacturers (OEMs) have been developing homogenous surface lighting which shows a design aspect having a different look and desirable appearance. Surface lighting developed to date includes Light Emitting Diode (LED) arrays having roughed surface injection light guides, and LED arrays having diffuser lenses. Because each LED has a variable viewing distribution angle, several LEDs are assembled into LED arrays as an approach to achieving a more uniform and homogeneous distribution of the surface emission. Lamp makers and automotive OEMs desire new solutions for surface lighting having a novel appearance, a competitive price, low electric power consumption, and easy assembly.

### SUMMARY

The present disclosure provides a lighting system having elongated lightguides disposed in elongated optical cavities that exhibit a uniform surface emission, a vehicle light assembly using the lighting system, and automotive exterior lamps incorporating the vehicle light assemblies. In one particular embodiment, the lighting system includes an elongated lightguide disposed in a reflective elongated optical cavity. The reflective elongated optical cavity can include a diffuse output surface, and the lighting system can have one or more LEDs positioned to inject light into the elongated lightguide. In one aspect, the present disclosure provides a lighting system that includes an elongated optical cavity defining an opening; an elongated lightguide disposed in the elongated optical cavity; a first light source disposed at a first input side of the elongated lightguide for emitting light, the emitted light entering the elongated lightguide from the first input side and propagating along the elongated lightguide primarily by total internal reflection; and a light diffusing film disposed at the opening of the elongated optical cavity, such that light emitted by the first light source exits the lighting system through the light diffusing film. The elongated lightguide includes light extracting features along a length of the elongated lightguide for extracting light that is otherwise confined in and propagates along the elongated lightguide primarily by total internal reflection. In another aspect, the present disclosure provides a vehicle light assembly that includes the lighting system. In yet another aspect, the present disclosure provides a taillight of a vehicle including the lighting system.

In yet another aspect, the present disclosure provides a lighting system that includes a first elongated hollow lightguide extending along a longitudinal direction and comprising first light extracting features along a length of the first elongated hollow lightguide for extracting light propagating within and along the first elongated hollow lightguide; a second elongated lightguide disposed in and extending along the longitudinal direction of the first elongated hollow lightguide, the second elongated lightguide having second light extracting features along a length of the second elongated lightguide for extracting light that propagates within and along the second elongated lightguide primarily by total internal reflection; and a first light source disposed at a first input side of the second elongated lightguide for emitting light, the emitted light entering the second elongated lightguide from the first input side and exiting the lighting system after being extracted by first and second light extracting features. In yet another aspect, the present disclosure provides a vehicle light assembly including the lighting system. In yet another aspect, the present disclosure provides a taillight of a vehicle including the lighting system.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A shows a perspective schematic view of a lighting system;

FIG. 1B shows a cross-sectional schematic view of a lighting system;

FIG. 1C shows a cross-sectional schematic view of a lighting system; and

FIG. 2 shows a perspective schematic cutaway view of a lighting system.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure provides a lighting system having elongated lightguides disposed in elongated optical cavities that exhibit a uniform surface emission, a vehicle light assembly using the lighting system, and automotive exterior lamps incorporating the vehicle light assemblies. In one particular embodiment, the lighting system includes an elongated lightguide, such as a 3M Light string RMF63 available from 3M Company, disposed in a reflective elongated optical cavity. The reflective elongated optical cavity can include a diffuse output surface, and the lighting system can have one or more LEDs positioned to inject light into the elongated lightguide. In some cases, the uniformity of the illumination from the lighting system can depend on the gap between the elongated lightguide and diffuse output surface, as described elsewhere.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

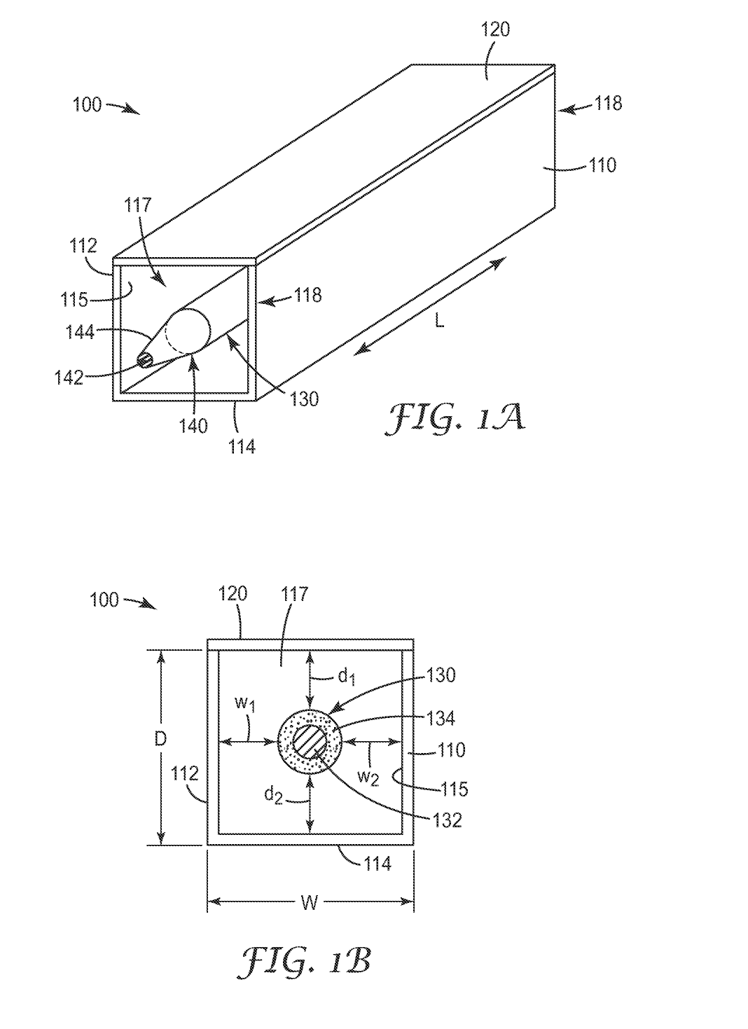

FIG. 1A shows a perspective schematic view of a lighting system 100, according to one aspect of the disclosure. Lighting system 100 includes an elongated optical cavity 117 comprising opposing side walls 110 and 112, bottom 114, opposing first and second ends 116 and 118, and light diffusing film 120 covering an opening of the elongated optical cavity 117. The light diffusing film can be primarily a surface diffuser, or it can be primarily a volume diffuser. In some cases additional light management films including, for example, a brightness enhancement film (not shown), can be disposed between the light diffusing film 120 and the elongated optical cavity 117, for increasing an on-axis brightness of the lighting system by recycling light, as known to one of ordinary skill in the art.

An interior surface 115 of each of the opposing side walls 110 and 112, and bottom 114, is at least somewhat reflective to light, and can include an optically diffuse reflective surface, an optically specular reflective surface, or a combination of diffuse and specular reflective surfaces. In one particular embodiment, the light reflecting interior surface can have an average reflectance of at least 80%, or at least 90%, in a visible wavelength range of the electromagnetic spectrum. In some cases, for example, an Enhanced Specular Reflector film (ESR, available from 3M Company) may be used; ESR film has reflectance of greater than 98%.

An elongated lightguide 130 is disposed in the elongated optical cavity 117 extending along a longitudinal direction “L”. The elongated lightguide 130 includes a first light injector 140 disposed adjacent the first end 116 of the elongated optical cavity 117 and configured to inject light from a first light source 142 into the elongated lightguide 130 after passing through an optional light collimator 144. The first light source 142 can include one or more LEDs, and in some cases, the one or more LEDs can emit the same or different wavelength light, such that a resulting color of the injected light can be varied as desired. In some cases, a second light source (not shown) can be disposed in a similar manner adjacent the opposing second end 118 of the elongated optical cavity 117. Each of the light sources can be independently selected from at least one of a light emitting diode (LED), an organic light emitting diode (OLED), a laser diode (LD), a cold cathode fluorescent lamp (CCFL), and an external electrode fluorescent lamp (EEFL). In some cases, the light source can be selected to emit red, yellow, amber, green, blue, or white light, or a combination thereof.

The elongated lightguide 130 includes light extracting features (not shown) along a length of the elongated lightguide 130 for extracting light that is otherwise confined in and propagates along the elongated lightguide 130. In some cases, the light extracting features can be surface structures that are known in the art to extract light travelling within lightguides. In some case, the light extracting features can be features interior to the elongated lightguide, such as, for example, light diffusing particles, that are known in the art to extract light travelling within lightguides. In one particular embodiment, the light extracting features can comprise a plurality of discrete spaced apart particles dispersed and embedded in the elongated lightguide 130. In one particular embodiment, the light extracting features can comprise a plurality of discrete spaced apart notches formed in an exterior surface of the outer cladding 134 of the elongated lightguide 130. The light from the first light source 142 emits light that propagates along the elongated lightguide 130 primarily by total internal reflection, and can be extracted into the elongated optical cavity 117 by the light extracting features.

FIG. 1B shows a cross-sectional schematic view of a lighting system 100, according to one aspect of the disclosure. Lighting system 100 includes an elongated optical cavity 117 comprising opposing side walls 110 and 112, bottom 114, and light diffusing film 120 covering an opening of the elongated optical cavity 117. An interior surface 115 of each of the opposing side walls 110 and 112, and bottom 114, is at least somewhat reflective to light, and can include a diffuse reflective surface, a specular reflective surface, or a combination of diffuse and specular reflective surfaces.

An elongated lightguide 130 is disposed in the elongated optical cavity 117, and includes a central core 132 and an outer cladding 134. It is to be understood that although the cross-section of the elongated lightguide 130 shown in FIG. 1B is shown to be circular, any desired cross-sectional shape can be used, including ovals, ellipsoids, mushroom-shapes, and polygonal cross-sections. In some cases, both the central core 132 and the outer cladding 134 can be fabricated from materials that have a low absorption for visible light, and the refractive index of the core can be greater than the refractive index of the outer cladding, to promote TIR throughout the elongated lightguide 130, as known to one of skill in the art. In some cases, the central core 132 can instead be a gas such as air, and the outer cladding 134 can include a partially reflective material to promote multiple reflections as light propagates through the elongated lightguide 130. In some cases, the outer cladding 134 can further include materials such as phosphors that can alter the color distribution of light passing through the outer cladding 134.

The lighting system 100 can have a depth “D” and a width “W” that can each vary independently along the longitudinal direction “L” (shown in FIG. 1A), or they can independently be constant along the longitudinal direction “L”. In one particular embodiment, the elongated optical cavity 117 comprises a maximum length along the longitudinal direction “L” of the elongated optical cavity 117, a maximum depth “Dmax” along a depth direction normal to the light diffusing film 120, and a maximum width “Wmax” along a width direction perpendicular to the longitudinal and depth directions, the maximum depth “Dmax” being greater than the maximum width “Wmax”. In one particular embodiment, the ratio of the maximum width “Wmax” to the maximum depth “Dmax”, or “Wmax/Dmax”, “Dmax/Wmax” being at least 0.5.

The elongated lightguide 130 can be positioned in the elongated optical cavity 117 in any desired position such that the elongated lightguide 130 has a first and second width separation “w1” and “w2” from the first and opposing second side walls 110 and 112. Further, the elongated lightguide 130 has a first and second depth separation “d1” and “d2” from the light diffusing film 120 and the bottom 114, respectively. In one particular embodiment, a maximum depth separation between the elongated lightguide 130 and the bottom 114 of elongated optical cavity 117 is less than a minimum depth separation between the elongated lightguide 130 and the light diffusing film 120. Each of the first and second width separations “w1” and “w2” and the first and second depth separations “d1” and “d2” can vary independently along the length of the elongated optical cavity 117, or they can independently remain constant along the length of the elongated optical cavity 117.

FIG. 1C shows a cross-sectional schematic view of a lighting system 100, according to one aspect of the disclosure. Each of the elements 110-130 shown in FIG. 1C correspond to like-numbered elements 110-130 shown in FIG. 1B, which have been described previously. For example, bottom 114 shown in FIG. 1C corresponds to bottom 114 shown in FIG. 1B, and so on. In FIG. 1C, a securing clip 150 is shown to be secured at base 152 to bottom 114 of elongated optical cavity 117. Securing clip 150 includes a plurality of contact points 155 that are shown to be contacting and securing elongated lightguide 130. The contacting and securing positions of contact points 155 are generally small, such that the loss of light through these positions is kept to a minimum Securing clip 150 can be fabricated from any suitable material including plastics and metals. In one particular embodiment, the securing clips 150 can be positioned as desired along the longitudinal length “L” of the elongated optical cavity 117 to position the elongated lightguide 130 at a desired separation distance from each of the opposing side walls 110, 112 and the light diffusing film 120.

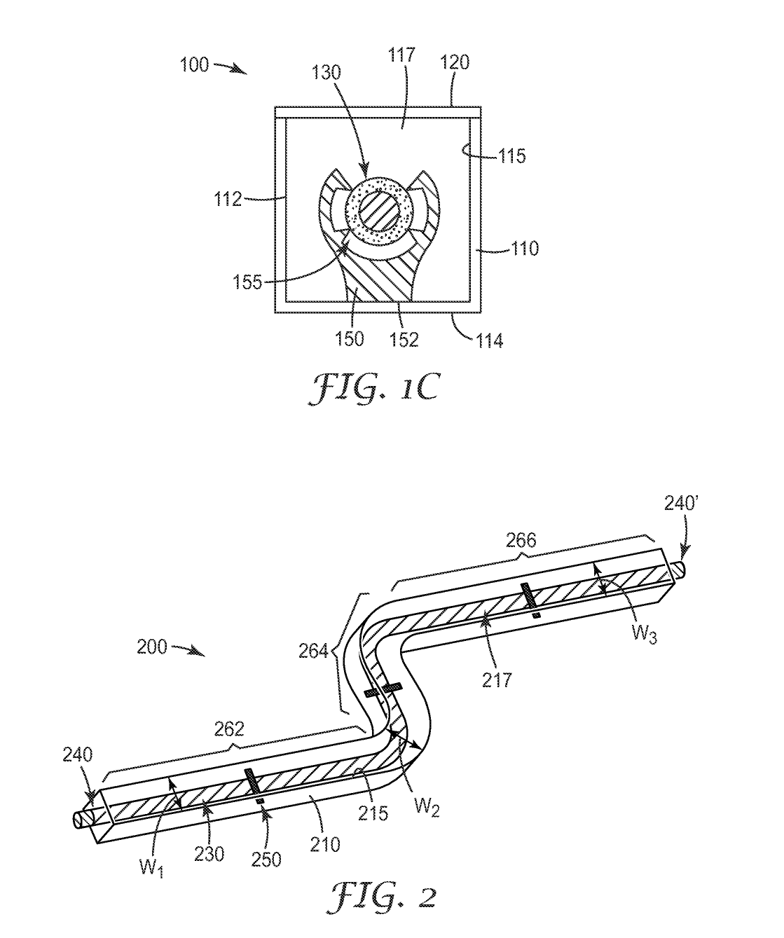

FIG. 2 shows a perspective schematic cutaway view of a lighting system 200, according to one aspect of the disclosure. Each of the elements 210-250 shown in FIG. 2 correspond to like-numbered elements 110-130 shown in FIG. 1C, which have been described previously. For example, first side wall 210 shown in FIG. 2 corresponds to first sidewall 110 shown in FIG. 1C, and so on. In FIG. 2, lighting system 200 includes a first light injector 240 and an optional second light injector 240′, each positioned to inject light into opposing ends of the elongated lightguide 230. The elongated lightguide 230 can extend over the entire length of the cavity (shown), or can be only in a portion of the cavity (not shown), as desired. In some cases, the elongated lightguide 230 can span at least 80%, or at least 90% of an entire length of the elongated optical cavity 217, and can also include any desired number and positioning of securing clips 250, as described elsewhere.

Each of the first and optional second light injector 240, 240′ can be positioned within elongated optical cavity 217, or they can be positioned exterior to the elongated optical cavity 217, as shown. The width of the lighting system, for example widths w1, w2, w3, can be constant along the length of the elongated optical cavity 217, or they can vary as desired. In some cases, the elongated optical cavity 217 can have a maximum width, e.g. w2, at a first location between the two opposing ends, and the width can taper from the maximum width w2 to a minimum width w1 and/or w2 adjacent one or both of the opposing ends.

In one particular embodiment shown in FIG. 2, lighting system 200 includes linear portions 262, 266, and curved/arcuate portion 264 between them. Any desired number of linear and/or curved sections can be joined together to make a lighting system 200. In some cases, the elongated optical cavity 217 can have a zig-zag shape, as shown. The lighting system 200 can be used as a portion of a vehicle light assembly, such as a taillight of a vehicle, and may further include a protective cover disposed on the light diffusing film.

### EXAMPLES

A test box was fabricated to simulate a lighting assembly similar to that shown in FIGS. 1A and 1B. The test box had a length of 300 mm, a width that was set to 10 mm, 30 mm, or 50 mm; and a depth that was set to 10 mm, 20 mm, or 30 mm. A reflection treatment of ESR film (available from 3M Company) was applied to the interior surfaces of the box, and a diffuser sheet (White diffuser PC, 3-4 mm thick, available from IS-Optics Co. LTd) was positioned at the opening of test box. The elongated lightguide was 320 mm in length (Light String RMFH63, available from 3M Company), and 2 WH Osram LEDs driven at a current of 350 mA, were positioned with a 0.5 mm gap at one end of the elongated lightguide.

The luminance at the diffuser sheet was measured using a CS100A Luminance and Color Meter and luminance intensity was measured using a CL200 Chroma Meter (both available from Konica Minolta). The luminance was measured at 12 positions along the diffuser sheet surface: at each of 4 different positions down the length test box, a measurement was taken in the center and near each edge of the sheet. The data is shown in TABLE 1, below: units are luminance (cd/m²) for each of the combinations of width and depth (e.g., W50 D10 corresponds to 50 mm width and 10 mm depth, and so on); center, left, right (e.g., C1, L1, R1 corresponds to center, left, and right of position 1); uniformity (Unif=maximum luminance/minimum luminance) and luminous intensity (LI).

TABLE 1

| | W50 | W50 | W50 | W30 | W30 | W30 | W10 | W10 | W10 |
|---|---|---|---|---|---|---|---|---|---|
| | D10 | D20 | D30 | D10 | D20 | D30 | D10 | D20 | D30 |
| C1 | 1606 | 1214 | 1080 | 2100 | 1672 | 1531 | 3585 | 3168 | 2830 |
| L1 | 806 | 969 | 1048 | 1490 | 1572 | 1570 | 2974 | 2704 | 2464 |
| R1 | 840 | 973 | 940 | 1657 | 1659 | 1539 | 3127 | 2833 | 2541 |
| C2 | 1836 | 1303 | 1066 | 2428 | 1773 | 1577 | 4246 | 3734 | 3344 |
| L2 | 921 | 1052 | 1021 | 1705 | 1734 | 1539 | 3647 | 3312 | 3008 |
| R2 | 945 | 1037 | 922 | 1911 | 1796 | 1602 | 3698 | 3295 | 2905 |
| C3 | 1968 | 1373 | 1040 | 2527 | 1793 | 1503 | 4534 | 3845 | 3240 |
| L3 | 968 | 1061 | 954 | 1759 | 1719 | 1466 | 3893 | 3419 | 2937 |
| R3 | 976 | 1032 | 870 | 1964 | 1779 | 1529 | 3871 | 3330 | 2761 |
| C4 | 2290 | 1289 | 759 | 2788 | 1549 | 1136 | 3839 | 2728 | 2175 |
| L4 | 765 | 812 | 648 | 1442 | 1345 | 1124 | 3103 | 2376 | 1955 |
| R4 | 698 | 747 | 567 | 1661 | 1404 | 1142 | 3218 | 2322 | 1799 |
| Ave | 1218 | 1072 | 910 | 1953 | 1650 | 1438 | 3645 | 3089 | 2663 |
| Unif | 3.280 | 1.839 | 1.907 | 1.934 | 1.335 | 1.426 | 1.525 | 1.656 | 1.859 |
| LI | 12.6 | 10.8 | 9 | 17.1 | 15.3 | 13.5 | 18.9 | 17.1 | 14.4 |

Generally, the luminance increases as the depth and width decreases; the uniformity appears to become better for depths of about 20-25 mm and widths of about 20-40 mm; and the luminous intensity increases as the depth decreases and the width increases. Uniformity values less than about 1.8 appear to be more visually acceptable.

The present invention generally can provide an effective way to make surface lighting for Automotive exterior Tail and Position lamps. The smaller number of LEDs, lower power consumption, design flexibility, easy optical and assembly design, and cost competitiveness, can be enabled by use of this surface lighting using elongated light string.

Following are a list of embodiments of the present disclosure.

Item 1 is a lighting system, comprising: an elongated optical cavity defining an opening; an elongated lightguide disposed in the elongated optical cavity and extending along a longitudinal direction of the elongated optical cavity, the elongated lightguide comprising light extracting features along a length of the elongated lightguide for extracting light that is otherwise confined in and propagates along the elongated lightguide primarily by total internal reflection; a first light source disposed at a first input side of the elongated lightguide for emitting light, the emitted light entering the elongated lightguide from the first input side and propagating along the elongated lightguide primarily by total internal reflection; and a light diffusing film disposed at the opening of the elongated optical cavity, such that light emitted by the first light source exits the lighting system through the light diffusing film.

Item 2 is the lighting system of item 1, wherein the elongated optical cavity comprises a plurality of substantially linear sections joined by one or more arcuate sections.

Item 3 is the lighting system of item 1 or item 2, wherein the elongated optical cavity is piecewise linear along the longitudinal direction of the elongated optical cavity.

Item 4 is the lighting system of item 1 to item 3, wherein the elongated optical cavity is piecewise curved along the longitudinal direction of the elongated optical cavity.

Item 5 is the lighting system of item 1 to item 4, wherein the elongated optical cavity has a constant width along the longitudinal direction of the elongated optical cavity.

Item 6 is the lighting system of item 1 to item 5, wherein a width of the elongated optical cavity varies along the longitudinal direction of the elongated optical cavity.

Item 7 is the lighting system of item 1 to item 6, wherein the elongated optical cavity has a maximum width at a first location between the first input side and an opposite end side, the width tapering away from the first location toward each of the first input side and the opposite end side.

Item 8 is the lighting system of item 1 to item 7, wherein the elongated optical cavity comprises two substantially linear segments joined at a bend location, the elongated optical cavity having a maximum width at the bend location, the width tapering away from the bend location along each of the two linear segments.

Item 9 is the lighting system of item 1 to item 8, wherein the elongated optical cavity has a zig-zag shape.

Item 10 is the lighting system of item 1 to item 9, wherein the elongated optical cavity has a substantially constant width along the longitudinal direction of the elongated optical cavity.

Item 11 is the lighting system of item 1 to item 10, wherein the elongated optical cavity has a substantially constant depth along the longitudinal direction of the elongated optical cavity.

Item 12 is the lighting system of item 1 to item 11, wherein a depth of the elongated optical cavity varies along the longitudinal direction of the elongated optical cavity.

Item 13 is the lighting system of item 1 to item 12, wherein the elongated optical cavity comprises opposing side walls and opposing end walls joining the side walls, the opening spanning the side and end walls.

Item 14 is the lighting system of item 1 to item 13, wherein the elongated optical cavity has a maximum depth d and the opening of the elongated optical cavity has a maximum lateral dimension w, d/w being at least 0.5.

Item 15 is the lighting system of item 1 to item 14, wherein the elongated optical cavity comprises an interior surface that is primarily optically diffusely reflective.

Item 16 is the lighting system of item 1 to item 15, wherein the elongated optical cavity comprises an interior surface that is primarily optically specularly reflective.

Item 17 is the lighting system of item 1 to item 16, wherein the elongated optical cavity comprises a light reflecting interior surface with an average reflectance of at least 80% in a visible wavelength range of the electromagnetic spectrum.

Item 18 is the lighting system of item 1 to item 17, wherein the elongated optical cavity comprises a light reflecting interior surface with an average reflectance of at least 90% in a visible wavelength range of the electromagnetic spectrum.

Item 19 is the lighting system of item 1 to item 18, wherein the elongated optical cavity comprises a maximum length along the longitudinal direction of the elongated optical cavity, a maximum depth along a depth direction normal to the light diffusing film, and a maximum width along a width direction perpendicular to the longitudinal and depth directions, the maximum depth being greater than the maximum width.

Item 20 is the lighting system of item 1 to item 19, wherein the elongated lightguide has a round cross-sectional profile along the length of the elongated lightguide.

Item 21 is the lighting system of item 1 to item 20, wherein the elongated lightguide has a mushroom cross-sectional profile along the length of the elongated lightguide.

Item 22 is the lighting system of item 1 to item 21, wherein the elongated lightguide comprises a higher index core surrounded by a lower index cladding.

Item 23 is the lighting system of item 1 to item 22, wherein a maximum separation between the elongated lightguide and a bottom of the elongated optical cavity is less than a minimum separation between the elongated lightguide and the opening.

Item 24 is the lighting system of item 1 to item 23, wherein a separation between the elongated lightguide and a bottom of the elongated optical cavity varies along the length of the elongated lightguide.

Item 25 is the lighting system of item 1 to item 24, wherein the elongated lightguide spans at least 80% of an entire length of the elongated optical cavity.

Item 26 is the lighting system of item 1 to item 25, wherein the elongated lightguide spans at least 90% of an entire length of the elongated optical cavity.

Item 27 is the lighting system of item 1 to item 26, wherein the elongated lightguide has a unitary construction.

Item 28 is the lighting system of item 1 to item 27, wherein the elongated lightguide comprises a first elongated lightguide an end of which is optically coupled to an end of a second elongated lightguide.

Item 29 is the lighting system of item 1 to item 28, wherein the light extracting features comprise a plurality of discrete spaced apart particles dispersed and embedded in the elongated lightguide.

Item 30 is the lighting system of item 1 to item 29, wherein the light extracting features comprise a plurality of discrete spaced apart notches formed in an exterior surface of the elongated lightguide.

Item 31 is the lighting system of item 1 to item 30, wherein at least some light rays extracted from the elongated lightguide by the light extracting features undergo at least one reflection from an interior surface of the elongated optical cavity before exiting the lighting system through the light diffusing film.

Item 32 is the lighting system of item 1 to item 31, wherein the first light source is disposed outside the elongated optical cavity.

Item 33 is the lighting system of item 1 to item 32, wherein the first light source is disposed inside the elongated optical cavity.

Item 34 is the lighting system of item 1 to item 33, wherein the first light source comprises at least one of a light emitting diode (LED), an organic light emitting diode (OLED), a laser diode (LD), a cold cathode fluorescent lamp (CCFL), and an external electrode fluorescent lamp (EEFL).

Item 35 is the lighting system of item 1 to item 34, wherein the first light source emits red, yellow, amber, green, blue, or white light, or a combination thereof.

Item 36 is the lighting system of item 1 to item 35, further comprising a second light source disposed at a second input side of the elongated lightguide opposite the first input side, light emitted light by the second light source entering the elongated lightguide from the second input side and propagating along the elongated lightguide primarily by total internal reflection.

Item 37 is the lighting system of item 36, wherein the first and second light sources emit different color light.

Item 38 is the lighting system of item 1 to item 37, wherein the light diffusing film is primarily a surface diffuser.

Item 39 is the lighting system of item 1 to item 38, wherein the light diffusing film is primarily a volume diffuser.

Item 40 is the lighting system of item 1 to item 39, further comprising a brightness enhancement film disposed between the light diffusing film and the elongated optical cavity for increasing an on-axis brightness of the lighting system by recycling light.

Item 41 is a vehicle light assembly comprising the lighting system of item 1 to item 40.

Item 42 is the vehicle light assembly of item 41 further comprising a cover disposed on the light diffusing film.

Item 43 is a taillight of a vehicle comprising the lighting system of item 1 to item 42.

Item 44 is a lighting system, comprising: a first elongated hollow lightguide extending along a longitudinal direction and comprising first light extracting features along a length of the first elongated hollow lightguide for extracting light propagating within and along the first elongated hollow lightguide; a second elongated lightguide disposed in and extending along the longitudinal direction of the first elongated hollow lightguide, the second elongated lightguide comprising second light extracting features along a length of the second elongated lightguide for extracting light that propagates within and along the second elongated lightguide primarily by total internal reflection; and a first light source disposed at a first input side of the second elongated lightguide for emitting light, the emitted light entering the second elongated lightguide from the first input side and exiting the lighting system after being extracted by first and second light extracting features.

Item 45 is the lighting system of item 44, wherein the first elongated hollow lightguide comprises a plurality of substantially linear sections joined by one or more arcuate sections.

Item 46 is the lighting system of item 44 or item 45, wherein the first elongated hollow lightguide is piecewise linear along the longitudinal direction.

Item 47 is the lighting system of item 44 to item 46, wherein the first elongated hollow lightguide is piecewise curved along the longitudinal direction.

Item 48 is the lighting system of item 44 to item 47, wherein the first elongated hollow lightguide has a constant width along the longitudinal direction.

Item 49 is the lighting system of item 44 to item 48, wherein a width of the first elongated hollow lightguide varies along the longitudinal direction.

Item 50 is the lighting system of item 44 to item 49, wherein the first elongated hollow lightguide has a maximum width at a first location between the first input side and an opposite end side, the width tapering away from the first location toward each of the first input side and the opposite end side.

Item 51 is the lighting system of item 44 to item 50, wherein the first elongated hollow lightguide comprises two substantially linear segments joined at a bend location, the first elongated hollow lightguide having a maximum width at the bend location, the width tapering away from the bend location along each of the two linear segments.

Item 52 is the lighting system of item 44 to item 51, wherein the first elongated hollow lightguide has a zig-zag shape.

Item 53 is the lighting system of item 44 to item 52, wherein the first elongated hollow lightguide has a substantially constant width along the longitudinal direction.

Item 54 is the lighting system of item 44 to item 53, wherein the first elongated hollow lightguide has a substantially constant depth along the longitudinal direction.

Item 55 is the lighting system of item 44 to item 54, wherein a depth of the first elongated hollow lightguide varies along the longitudinal direction.

Item 56 is the lighting system of item 44 to item 55, wherein the first elongated hollow lightguide comprises opposing side walls and opposing end walls joining the side walls, and an opening spanning the side and end walls.

Item 57 is the lighting system of item 56, wherein the first elongated hollow lightguide has a maximum depth d and the opening has a maximum lateral dimension w, d/w being at least 0.5.

Item 58 is the lighting system of item 44 to item 57, wherein the first elongated hollow lightguide comprises an interior surface that is primarily optically diffusely reflective.

Item 59 is the lighting system of item 44 to item 58, wherein the first elongated hollow lightguide comprises an interior surface that is primarily optically specularly reflective.

Item 60 is the lighting system of item 44 to item 59, wherein the first elongated hollow lightguide comprises a light reflecting interior surface with an average reflectance of at least 80% in a visible wavelength range of the electromagnetic spectrum.

Item 61 is the lighting system of item 44 to item 60, wherein the first elongated hollow lightguide comprises a light reflecting interior surface with an average reflectance of at least 90% in a visible wavelength range of the electromagnetic spectrum.

Item 62 is the lighting system of item 44 to item 61, wherein the first elongated hollow lightguide comprises a maximum length along the longitudinal direction, a maximum depth along a depth direction normal to the first light extraction features, and a maximum width along a width direction perpendicular to the longitudinal and depth directions, the maximum depth being greater than the maximum width.

Item 63 is the lighting system of item 44 to item 62, wherein the second elongated lightguide has a round cross-sectional profile along the length of the second elongated lightguide.

Item 64 is the lighting system of item 44 to item 63, wherein the second elongated lightguide has a mushroom cross-sectional profile along the length of the second elongated lightguide.

Item 65 is the lighting system of item 44 to item 64, wherein the second elongated lightguide comprises a higher index core surrounded by a lower index cladding.

Item 66 is the lighting system of item 44 to item 65, wherein a maximum separation between the second elongated lightguide and a bottom of the first elongated hollow lightguide is less than a minimum separation between the second elongated lightguide and the opening.

Item 67 is the lighting system of item 44 to item 66, wherein a separation between the second elongated lightguide and a bottom of the first elongated hollow lightguide varies along the longitudinal direction.

Item 68 is the lighting system of item 44 to item 67, wherein the second elongated lightguide spans at least 80% of an entire length of the first elongated hollow lightguide.

Item 69 is the lighting system of item 44 to item 68, wherein the second elongated lightguide spans at least 90% of an entire length of the first elongated hollow lightguide.

Item 70 is the lighting system of item 44 to item 69, wherein the second elongated lightguide has a unitary construction.

Item 71 is the lighting system of item 44 to item 70, wherein the second elongated lightguide comprises a third elongated lightguide an end of which is optically coupled to an end of a fourth elongated lightguide.

Item 72 is the lighting system of item 44 to item 71, wherein the second light extracting features comprise a plurality of discrete spaced apart particles dispersed and embedded in the second elongated lightguide.

Item 73 is the lighting system of item 44 to item 72, wherein the second light extracting features comprise a plurality of discrete spaced apart notches formed in an exterior surface of the second elongated lightguide.

Item 74 is the lighting system of item 44 to item 73, wherein at least some light rays extracted from the second elongated lightguide by the second light extracting features undergo at least one reflection from an interior surface of the first elongated hollow lightguide before exiting the lighting system through the first light extracting features.

Item 75 is the lighting system of item 44 to item 74, wherein the first light source is disposed outside the first elongated hollow lightguide.

Item 76 is the lighting system of item 44 to item 75, wherein the first light source is disposed inside the first elongated hollow lightguide.

Item 77 is the lighting system of item 44 to item 76, wherein the first light source comprises at least one of a light emitting diode (LED), an organic light emitting diode (OLED), a laser diode (LD), a cold cathode fluorescent lamp (CCFL), and an external electrode fluorescent lamp (EEFL).

Item 78 is the lighting system of item 44 to item 77, wherein the first light source emits red, yellow, amber, green, blue, or white light, or a combination thereof.

Item 79 is the lighting system of item 44 to item 78, further comprising a second light source disposed at a second input side of the second elongated lightguide opposite the first input side, light emitted by the second light source entering the second elongated lightguide from the second input side and propagating along the second elongated lightguide primarily by total internal reflection.

Item 80 is the lighting system of item 79, wherein the first and second light sources emit different color light.

Item 81 is the lighting system of item 44 to item 80, wherein the first light extracting features are primarily a surface diffuser.

Item 82 is the lighting system of item 44 to item 81, wherein the first light extracting features are primarily a volume diffuser.

Item 83 is the lighting system of item 44 to item 82, further comprising a brightness enhancement film disposed between the first light extracting features and the first elongated hollow lightguide for increasing an on-axis brightness of the lighting system by recycling light.

Item 84 is a vehicle light assembly comprising the lighting system of item 44 to item 83.

Item 85 is the vehicle light assembly of item 84 further comprising a cover disposed on the first light extracting features.

Item 86 is a taillight of a vehicle comprising the lighting system of item 44 to item 85.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1-10. (canceled)

11. A lighting system comprising:
an elongated optical cavity defining an opening;
an elongated lightguide disposed in the elongated optical cavity and extending along a longitudinal direction of the elongated optical cavity, the elongated lightguide comprising light extracting features along a length of the elongated lightguide for extracting light that is otherwise confined in and propagates along the elongated lightguide primarily by total internal reflection;
a first light source disposed at a first input side of the elongated lightguide for emitting light, the emitted light entering the elongated lightguide from the first input side and propagating along the elongated lightguide primarily by total internal reflection; and
a light diffusing film disposed at the opening of the elongated optical cavity, such that light emitted by the first light source exits the lighting system through the light diffusing film.

12. The lighting system of claim 11, wherein the elongated optical cavity comprises a plurality of substantially linear sections joined by one or more arcuate sections.

13. The lighting system of claim 11, wherein the elongated optical cavity comprises two substantially linear segments joined at a bend location, the elongated optical cavity having a maximum width at the bend location, the width tapering away from the bend location along each of the two linear segments.

14. The lighting system of claim 11, wherein a depth of the elongated optical cavity varies along the longitudinal direction of the elongated optical cavity.

15. The lighting system of claim 11, wherein the elongated optical cavity comprises opposing side walls and opposing end walls joining the side walls, the opening spanning the side and end walls.

16. The lighting system of claim 11, wherein the elongated optical cavity comprises an interior surface that is primarily optically diffusely reflective.

17. The lighting system of claim 11, wherein the elongated optical cavity comprises an interior surface that is primarily optically specularly reflective.

18. The lighting system of claim 11, wherein the elongated lightguide spans at least 80% of an entire length of the elongated optical cavity.

19. The lighting system of claim 11, wherein the elongated lightguide spans at least 90% of an entire length of the elongated optical cavity.

20. The lighting system of claim 11, wherein the elongated lightguide comprises a first elongated lightguide an end of which is optically coupled to an end of a second elongated lightguide.

21. The lighting system of claim 11, wherein the first light source is disposed outside the elongated optical cavity.

22. The lighting system of claim 11 further comprising a brightness enhancement film disposed between the light diffusing film and the elongated optical cavity for increasing an on-axis brightness of the lighting system by recycling light.

23. A vehicle light assembly comprising the lighting system of claim 11.

24. A taillight of a vehicle comprising the lighting system of claim 11.

25. A lighting system comprising:
a first elongated hollow lightguide extending along a longitudinal direction and comprising first light extracting features along a length of the first elongated hollow lightguide for extracting light propagating within and along the first elongated hollow lightguide;
a second elongated lightguide disposed in and extending along the longitudinal direction of the first elongated hollow lightguide, the second elongated lightguide comprising second light extracting features along a length of the second elongated lightguide for extracting light that propagates within and along the second elongated lightguide primarily by total internal reflection; and
a first light source disposed at a first input side of the second elongated lightguide for emitting light, the emitted light entering the second elongated lightguide from the first input side and exiting the lighting system after being extracted by first and second light extracting features.

26. The lighting system of claim 25, wherein a depth of the first elongated hollow lightguide varies along the longitudinal direction.

27. The lighting system of claim 25, wherein the first elongated hollow lightguide comprises an interior surface that is primarily optically specularly reflective.

28. The lighting system of claim 25, wherein the second elongated lightguide has a mushroom cross-sectional profile along the length of the second elongated lightguide.

29. The lighting system of claim 25, wherein the second elongated lightguide comprises a higher index core surrounded by a lower index cladding.

30. The lighting system of claim 25, further comprising a brightness enhancement film disposed between the first light extracting features and the first elongated hollow lightguide for increasing an on-axis brightness of the lighting system by recycling light.

31. A vehicle light assembly comprising the lighting system of claim 25.

32. A taillight of a vehicle comprising the lighting system of claim 25.
